(19) United States
(12) Patent Application Publication
(10) Pub. No.: US 2011/0048263 A1
(43) Pub. Date: Mar. 3, 2011

(54) SHEET TRANSFER SYSTEM AND DUPLEX PRINTER USING SAME

(75) Inventors: Tomohiko SHIMODA, Ibaraki-ken (JP); Yoshiyuki OKADA, Ibaraki-ken (JP); Hitoshi ARAI, Ibaraki-ken (JP)

(73) Assignee: RISO KAGAKU CORPORATION, Tokyo (JP)

(21) Appl. No.: 12/868,802

(22) Filed: Aug. 26, 2010

(30) Foreign Application Priority Data
Aug. 31, 2009 (JP) P2009-199741

(51) Int. Cl. B41F 21/04

(52) U.S. Cl. 101/410

(57) ABSTRACT

A sheet transfer system includes a register roller working for transfer of a one-side printed print sheet and a non-printed print sheet, a pair of first guide plates working to guide the one-side printed print sheet to the register, and a pair of second guide plates working to guide the non-printed print sheet to the register. The first guide plates make an opening angle θ1 in between greater than an opening θ2(θ3) the second guide plates make in between.

### CROSS REFERENCE TO RELATED APPLICATION

The present application claims the benefit of priority under 35 U.S.C. §119 to Japanese Patent Application No. 2009-199741, filed on Aug. 31, 2009, the entire content of which is incorporated herein by reference.

### BACKGROUND OF THE INVENTION

1. Field of the Invention

The present invention relates to a sheet transfer system to be installed in a duplex printer, and particularly, to a sheet transfer system having a region for confluence between one-side printed print sheet and non-printed print sheet.

2. Description of Related Art

There are known transfer systems for print sheets employed in duplex printers. Japanese Patent Application Laying-Open Publication No. 2002-274731 has disclosed a duplex printer including a register roller, a first guide roller for transfer of non-printed print sheet to the register roller, and a second guide roller for reefed of one-side printed print sheet to the register roller.

In the duplex printer, there was a non-printed print sheet fed from a feed tray, to transfer to the register roller by the first guide roller. Afterward, the print sheet had images printed on one side, and was inverted. Next, the print sheet was transferred to the register roller by the second guide roller, to have images printed on the other side. Thereafter, the print sheet was discharged to complete a duplex printing.

### SUMMARY OF THE INVENTION

However, in a transfer system in the duplex printer, one-side printed print sheets were subject to affects such as those of ink to have tendencies to curl along edges at both transverse ends of print sheet, substantially over length thereof in a transfer direction. In such situations, print sheets being transferred by the second guide roller tended to have deviated positions relative to the register roller, with a resultant tendency for print sheets to undergo troubles in transfer, as an issue.

The present invention has been devised with such points in view, it being an object of the present invention to provide a sheet transfer system for duplex printers with adaptation to suppress transfer troubles.

To achieve the object described, according to an aspect of the present invention, there is a sheet transfer system comprising a register configured for a one-side printed print sheet and a non-printed print sheet in travel to be placed in a position, a first guide portion configured with a first opening to guide the one-side printed print sheet to the register, and a second guide portion configured with a second opening to guide the non-printed print sheet to the register, the first opening having an opening angle greater than an opening angle of the second opening.

### BRIEF DESCRIPTION OF DRAWINGS

FIG. 1 is a schematic diagram of a printer according to a first embodiment.

FIG. 2 is a schematic side view of a confluent portion.

FIG. 3 is an explanatory diagram of the confluent portion with guide members defining opening angles.

FIG. 4 is a schematic side view of a confluent portion according to a second embodiment.

FIG. 5 is a schematic side view of a confluent portion according to a third embodiment.

### DETAILED DESCRIPTION OF EMBODIMENTS

### First Embodiment

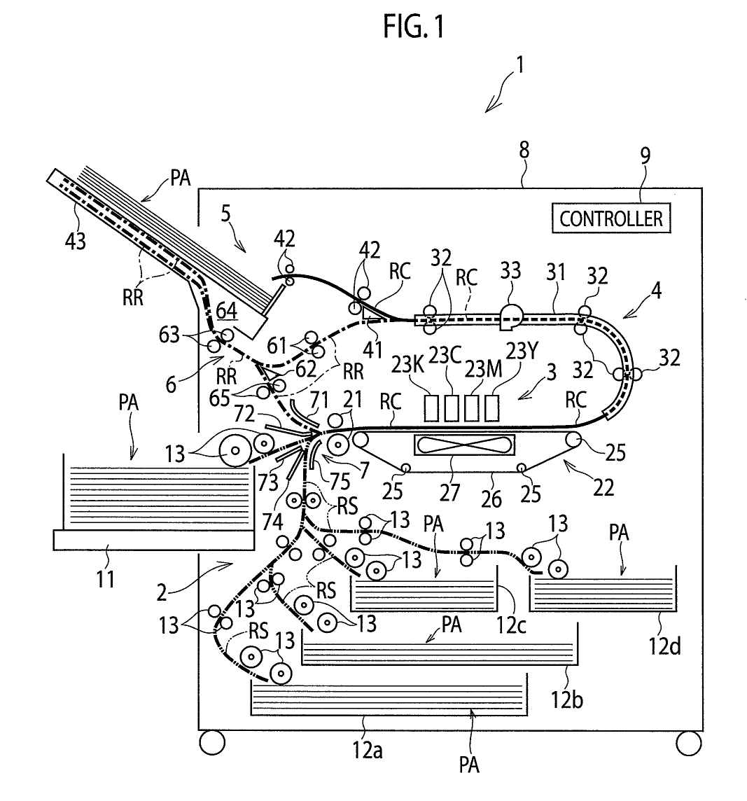

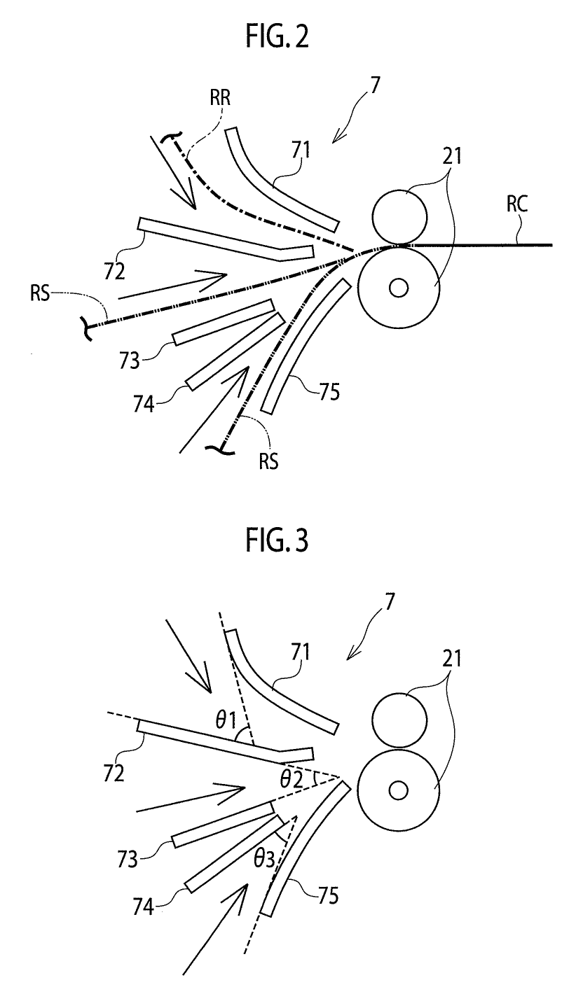

FIG. 1 illustrates an aqueous ink addressing inkjet type duplex printer including a sheet transfer system according to a first embodiment. As used herein, the aqueous ink means a moisture containing ink encompassing an O/W (Oil in Water) type and a W/O (Water in Oil) type emulsion ink. FIG. 2 is a schematic side view of a confluent portion. FIG. 3 is an explanatory diagram of the confluent portion with guide members defining opening angles.

In FIG. 1, those paths depicted by bold lines are transfer routes adapted for transfer of print sheets. Among the transfer routes, those depicted by solid lines and dashed lines constitute a normal route RC. Among the transfer routes, those depicted by chain lines constitute an inversion route RR. Among the transfer routes, those depicted by two-dot chain lines constitute a system of feed routes RS.

As illustrated in FIG. 1, the duplex printer 1 includes a feeding portion 2, a printing portion 3, a drying portion 4, a discharging portion 5, an inverting portion 6, and a confluent portion 7, as well as a controller 9 for controlling those portions, and a housing 8 for accommodating such portions. According to the first embodiment, the sheet transfer system is defined as a system comprising a combination of part of the printing portion 3 (with a later-described register roller 21 inclusive) and the confluent portion 7. This definition is applied to second and third embodiments, as well.

The feeding portion 2 is configured to feed a print sheet PA. The feeding portion 2 constitutes an upstream end of the transfer system. The feeding portion 2 includes a side feed rack 11, internal feed trays 12a, 12b, 12c, and 12d, and pairs of feed rollers 13. The side feed rack 11 and internal feed trays 12a, 12b, 12c, and 12d have print sheets PA stacked therein to be fed. Paired feed rollers 13 are controlled for transfer of a print sheet PA from the feed rack 11 or any one of feed trays 12a to 12d to the printing portion 3.

The printing portion 3 is configured to transfer a fed print sheet PA, printing images on the print sheet PA. The printing portion 3 is disposed downstream of the feeding portion 2. The printing portion 3 includes a register roller (as a register) 21, a belt transfer section 22, and an array of inkjet heads 23K, 23C, 23M, and 23Y.

The register roller 21 is configured to receive a non-printed print sheet PA fed from the feeding portion 2 through the confluent portion 7, and set in position, before sending the positioned non-printed print sheet PA to the belt transfer section 22. The register roller 21 is configured also to receive a one-side printed print sheet PA re-fed from the inverting portion 6 through the confluent portion 7, and set in position, to send to the belt transfer section 22.

The belt transfer section 22 is configured to hold thereon by sucking a print sheet PA sent thereover from the register roller 21, to transfer to the drying portion 4. The belt transfer section 22 includes four pulleys 25, a transfer belt 26, and a suction fan 27. The transfer belt 26 is applied over the four pulleys 25. The transfer belt 26 has suction holes formed therethrough. The suction fan 27 causes downward airstreams, whereby the print sheet PA is sucked onto suction holes of the transfer belt 26.

The array of inkjet heads 23K, 23C, 23M, and 23Y is configured to propel out droplets of aqueous inks onto a print sheet PA, thereby printing images thereon. Inkjet heads 23K, 23C, 23M, and 23Y are supplied with a black ink, a cyan ink, a magenta ink, and a yellow ink, respectively.

The drying portion 4 is configured to transfer a printed print sheet PA, while drying. The drying portion 4 is disposed downstream of the printing portion 3. The drying portion 4 includes a drying duct 31, three pairs of transfer rollers 32, and a heating blower or fan 33.

The drying duct 31 is configured to guide a printed print sheet PA, while holding heat of air sent from the heating blower or fan 33. The drying duct 31 is built along the normal route RC. The drying duct 31 has a transfer space (non-depicted) defined therein as part of normal route RC for transfer of print sheet PA. The transfer rollers 32 are adapted to transfer the printed print sheet PA in the drying duct 31. The heating blower or fan 33 is configured to send heating air inside the drying duct 31, to thereby dry the printed print sheet PA being transferred in the drying duct 31.

The discharging portion 5 is configured to discharge a printed print sheet PA in a stacking manner. The discharging portion 5 is disposed downstream of the drying portion 4. The discharging portion 5 constitutes a downstream end of the normal route RC. The discharging portion 5 includes a route selector 41, two pairs of discharge rollers 42, and a stacking rack 43.

The route selector 41 is configured to select a transfer route of print sheet PA between the normal route RC and the inversion route PA to be used in duplex printing. Print sheets PA are each transferred to the stacking rack 43 or the inverting portion 6, whichever is selected by the route selector 41. The paired discharge rollers 42 are configured to discharge a print sheet PA onto the stacking rack 43. The stacking rack 43 is configured to stack thereon printed print sheets PA discharged by the discharge rollers 42. The stacking rack 43 is inclined to afford an enhanced edge trimming of discharged sheets.

The inverting portion 6 is configured to invert a one-side printed print sheet PA, to transfer to the printing portion 3. The inverting portion 6 includes a pair of outward rollers 61, a flipper 62, a pair of reciprocating rollers 63, a switchback section 64, and a pair of homeward rollers 65.

The paired outward rollers 61 are configured to receive a one-side printed print sheet PA transferred from the drying portion 4 through the route selector 41, and transfer to the paired reciprocating rollers 63. The flipper 62 is configured to receive a print sheet PA transferred by the outward rollers 61, and guide to the reciprocating rollers 63. The flipper 62 works to guide the print sheet PA being transferred by the reciprocating rollers 63, to the paired homeward rollers 65.

The reciprocating rollers 63 are configured to carry a print sheet PA into the switchback section 64. The reciprocating rollers 63 work to receive a print sheet PA carried out from the switchback section 64, and transfer to the homeward rollers 65. It is noted that the reciprocating rollers 63 have a direction of rotation in the carrying-in to the switchback section 64, which is opposite to a direction of rotation the reciprocating rollers 63 have in the carrying-out from the switchback section 64. The switchback section 64 works to receive a print sheet PA carried in by the reciprocating rollers 63, and carry out to the reciprocating rollers 63. The switchback section 64 is configured with an internal space defined inside the stacking rack 43. The homeward rollers 65 are configured to receive a print sheet PA transferred from the reciprocating rollers 63, and transfer to the register roller 21.

As illustrated in FIG. 2 and FIG. 3, the confluent portion 7 is configured to guide a received print sheet PA, whether it is printed or non-printed, to the register roller 21. The confluent portion 7 has five guide plates 71, 72, 73, 74, and 75. Among them, the guide plates 71 and 72 are adapted to cooperate with each other to work as a pair of specific constituent elements of a first guide portion according to the first embodiment. The guide plates 71 and 72 are configured as a first pair of guide plates tapered to define an opening (as a first opening) to be open to a printed print sheet PA carried out to re-feed from the switchback section 64. Among the guide plates 72, 73, 74, and 75, the guide plates 72 and 73 are adapted to cooperate with each other to work as a pair of collateral constituent elements of a second guide portion according to the first embodiment, the guide plates 72 and 73 being configured as a second pair of guide plates tapered to define an opening (as a second opening) to be open to a non-printed print sheet PA carried out to feed from the side feed rack 11. Further, the guide plates 74 and 75 are adapted to cooperate with each other to work as a pair of collateral constituent elements of the second guide portion according to the first embodiment, the guide plates 74 and 75 being configured as another second pair of guide plates tapered to define an opening (as another second opening) to be open to a non-printed print sheet PA carried out to feed from any one of the internal feed trays 12a to 12d. Like configuration will be employed also in the second and third embodiments.

As illustrated in FIG. 3, the first opening has an opening angle defined as a crossing angle (θ1) between tangential lines at sheet carry-in ends of the first pair of guide plates. The second openings each have an opening angle defined as a crossing angle (θ2 or θ3) between tangential lines at sheet carry-in ends of a corresponding one of the second pairs of guide plates. Providing such definitions, guide plates used may be circular in profile, or bent or flexed to have intersecting planar surfaces.

The guide plate 71 and the guide plate 72 cooperate with each other to receive a one-side printed print sheet PA transferred from the inverting portion 6, and guide to the register roller 21. The guide plates 71 and 72 have a transverse width substantially equal to a maximum printable width of print sheet PA. The guide plate 71 is formed to be circular in shape at an inlet end thereof. This permits a print sheet PA to be smoothly carried in between guide plates 71 and 72. The guide plate 72 is flexed at an intermediate part thereof. The guide plates 71 and 72 are disposed on opposite sides to each other with an end of the inversion route RR in between. The guide plate 71 and the guide plate 72 mutually cooperate to define an outlet opening in a vicinity of the register roller 21. The guide plate 72 and the guide plate 73 cooperate with each other to receive a non-printed print sheet PA fed from the side feed track 11, and guide to the register roller 21.

The guide plates 72 and 73 have a transverse width substantially equal to a maximum printable width of print sheet PA. The guide plates 72 and 73 are disposed on opposite sides to each other, with an end of the feed route RS from the side feed track 11 in between. The guide plate 72 and the guide plate 73 mutually cooperate to define an outlet opening in a vicinity of the register roller 21.

The guide plate 74 and the guide plate 75 cooperate with each other to receive a non-printed print sheet PA fed from any one of the internal feed trays 12a to 12d, and guide to the register roller 21. The guide plates 74 and 75 have a transverse width substantially equal to a maximum printable width of print sheet PA. The guide plate 75 is formed to be circular in shape. This permits a print sheet PA to be smoothly carried out to the register roller 21. The guide plates 74 and 75 are disposed on opposite sides to each other with an end of the feed route RS from the system of internal feed trays 12a to 12d in between. The guide plate 74 and the guide plate 75 mutually cooperate to define an outlet opening in a vicinity of the register roller 21.

Here, the print sheet PA re-fed from the inverting portion 6 is curled due to affects of aqueous inks printed on one side thereof. On the other hand, the print sheet PA fed from the feed rack 11 or any one of the feed trays 12a to 12d is non-printed, and remains substantially flat. Accordingly, between the inlet opening for a print sheet PA re-fed from the inverting portion 6 and the inlet openings for a print sheet fed from the feed rack 11 or any one of the feed trays 12a to 12d, the former had better be greater than the latter. In the duplex printer 1 with this point in view, the opening angle θ1 is set to be greater than the opening angles θ2 and θ3. That is, the guide plates 71 to 75 are formed and arranged in compliance with θ1>θ2 and θ1>θ3.

(Printing Actions)

Description is now made of printing actions of the duplex printer 1 according to the first embodiment.

First, description is made of actions in one-side printing. Initially, there is a non-printed print sheet PA being fed from the feed rack 11 or any one of the feed trays 12a to 12d, by associated feed rollers 13, along a feed route RS. If the print sheet PA is fed from the feed rack 11, it is guided by the combination of guide plate 72 and guide plate 73 in the confluent portion 7, to the register roller 21 in the printing portion 3. Instead, if the print sheet PA is fed from any one of the feed trays 12a to 12d, it is guided by the combination of guide plate 74 and guide plate 75 in the confluent portion 7, to the register roller 21 in the printing portion 3.

The printing portion 3 thus has a print sheet PA sent thereto by the register roller 21, and sucked by the suction fan 27 onto the transfer belt 26, to transfer therewith. Then, the inkjet heads 23K to 23Y propel out droplets of aqueous inks onto the print sheet PA being transferred, to print images thereon. Here, with aqueous inks being printed, the print sheet PA has tendencies to deform into a curled state. After the printing, the print sheet PA is still transferred at the belt transfer section 22, to forward into the drying duct 31 of the drying portion 4.

At the drying portion 4, the print sheet PA is transferred by transfer rollers 32 through a transfer space defined inside the drying duct 31, while being guided by wall of the drying duct 31. In the transfer space in the drying duct 31 there are streams of heated air sent from the heating blower or fan 31. Heated air is streaming along the transfer space in the drying duct 31. The print sheet PA being transferred in the drying duct 31 thus travels in heated air. Therefore, the print sheet PA having been moist with aqueous inks is dried in the drying duct 31, having moisture of aqueous inks promoted to permeate to the backside. As a result, the print sheet PA has reduced tendencies to curl. In due course, the print sheet PA is carried out from the drying duct 31, and transferred to the discharging portion 5. At the discharging portion 5, the print sheet PA is guided by the route selector 41, and carried by discharge rollers 42, to discharge onto the stacking rack 43. For any print sheet, the one-side printing is thus completed.

Next, description is made of actions in duplex (double side) printing. Initially there is a print sheet PA having images printed on one side thereof (referred herein to as a first print side), and transferred to the route selector 41, like that in one-side printing. In the duplex printing, the print sheet PA is guided by the route selector 41 to the inversion route RR of the inverting portion 6. At the inverting portion 6, the print sheet PA is forwarded by the outward rollers 61 to the reciprocating rollers 63, while being guided by the flipper 62. Then, the print sheet PA is carried by the reciprocating rollers 63 into the switchback section 64 for a temporary inversion, and carried out thereof to the reciprocating rollers 63. This print sheet PA is forwarded to the homeward rollers 65 by the reciprocating rollers 63 rotating in an opposite direction to the outward travel, while being guided by the flipper 62. As a result, the print sheet PA is inverted to transfer to the confluent portion 7. The print sheet PA undergoing affects of aqueous inks has tendencies to curl along edges at both transverse ends, substantially over length thereof in the transfer direction. To this point, between the guide plate 71 and the guide plate 72, the opening angle θ1 is set to be greater than the opening angles θ2 and θ3. This permits the print sheet PA being curled, if any, to be smoothly carried in between the guide plate 71 and the guide plate 72. Thereafter, the print sheet PA is re-fed by the homeward rollers 65 to the register roller 21 in the printing portion 3, while being guided by the guide plates 71 and 72.

At the printing portion 3, the print sheet PA is transferred by the register roller 21 and the belt transfer section 22. In this travel, the print sheet PA has the other side thereof (referred herein to as a second print side) facing the inkjet heads 23K to 23Y. In this situation, the inkjet heads 23K to 23Y are controlled to print images on the second print side. In due course, the both-side printed print sheet PA is dried in the drying section 4, while being transferred therethrough. Then, the print sheet PA is guided by the route selector 41, and transferred to the discharging portion 5. Thereafter, the print sheet PA is discharged onto the stacking rack 43. For any sheet, the duplex printing of images on both first and second print sides thus comes to an end.

(Advantageous Effects of Printer)

Description is now made of advantageous effects of the duplex printer 1 according to the first embodiment.

In the duplex printer 1 described, the confluent portion 7 is configured with a first opening for one-side printed print sheets PA to be carried in thereto, and second openings for non-printed print sheets PA to be carried in thereto, the first opening being set up with an opening angle θ1 greater than opening angles θ2 and θ3 of the second openings. This configuration permits any print sheet PA as printed on one side and curled to be smoothly introduced between guide plates 71 and 72, to guide to the register roller 21. As a result, the duplex printer 1 has successfully suppressed troubles in transfer of print sheet PA from the confluent portion 7 to the register roller 21. Further, for non-printed print sheets PA subjected to less transfer troubles at the confluent portion 7, the duplex printer 1 has the second openings set up with reduced opening angles θ2 and θ3 thus affording to implement the confluent portion 7 in a minimized scale. Accordingly, the duplex printer 1 is adapted to suppress transfer troubles, allowing for a minimized scale.

### Second Embodiment

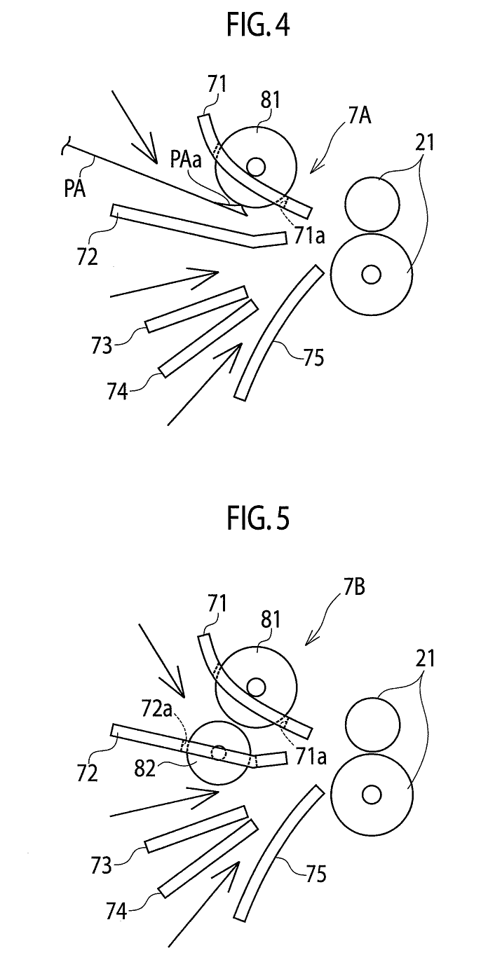

Description is now made of a second embodiment including a confluent portion modified from the embodiment described. FIG. 4 is a schematic side view of the confluent portion according to the second embodiment. It is noted that with respect to the embodiment described, like elements are designated by like reference signs, omitting redundancy.

As illustrated in FIG. 4, according to the second embodiment, there is a confluent portion 7A provided with an upper draw-in roller (as a draw-in member) 81 for a service to draw in a re-fed sheet. The upper draw-in roller 81 is configured to draw in a one-side printed print sheet PA, aiding the transfer to a register roller 21. The upper draw-in roller 81 is disposed between an inlet end of a guide plate 71 and the register roller 21. The upper draw-in roller 81 is partially inserted in a window 71a formed through the guide plate 71. At the confluent portion 7a, the one-side printed print sheet PA to be carried in has an upside as a non-printed side (i.e., a second print side) thereof facing upward. That is, the upper draw-in roller 81 is arranged to confront the non-printed side of one-side printed print sheet PA.

The upper draw-in roller 81 is driven to rotate by drive forces of a draw-in motor (non-depicted) controlled from a controller 9 (see FIG. 1). The controller 9 is adapted to control the upper draw-in roller 81 to make a transfer speed of a print sheet PA by the upper draw-in roller 81 faster than a transfer speed that might have been set to simply carry in the print sheet PA between the guide plate 71 and a guide plate 72. That is, the controller 9 is adapted for control to make the transfer speed by the upper draw-in roller 81 faster than a transfer speed by homeward rollers 65.

According to the second embodiment described, there is a one-side printed print sheet PA transferred by homeward rollers 65 of an inverting portion 6 to carry in between the guide plate 71 and the guide plate 72. The print sheet PA is pulled forward by the upper draw-in roller 81, while being guided by the guide plates 71 and 72, so even if the print sheet had an edge fold (as an occasionally folded edge or corner part) PAa, this part would have been unfolded by an increased transfer speed. According to the second embodiment, the confluent portion 7A is thus adapted to use an accelerated speed to draw in an edge fold or edge folds PAa of a one-side printed print sheet PA, affording to unfold or reduce the edge fold or edge folds PAa of print sheet PA. Further, the confluent portion 7A has the upper draw-in roller 81 facing a non-printed side of print sheet, allowing for suppressed image degradation, as well as enhanced smooth transfer of print sheet PA to the register roller 21.

It is noted that the second embodiment has similar advantageous effects to the first embodiment.

### Third Embodiment

Description is now made of a third embodiment including a confluent portion modified from the embodiments described. FIG. 5 is a schematic side view of the confluent portion according to the third embodiment. It is noted that with respect to the embodiments described, like elements are designated by like reference signs, omitting redundancy.

As illustrated in FIG. 5, according to the third embodiment, there is a confluent portion 7B provided with a lower draw-in roller 82 for a service to draw in a re-fed sheet. The lower draw-in roller 82 is disposed between an inlet end of a guide plate 72 and a register roller 21 composed of a pair of rollers. The lower draw-in roller 82 is partially inserted in a window 72a formed through the guide plate 72. Accordingly, the lower draw-in roller 82 is cooperative with an upper draw-in roller 81 to nip a print sheet PA to transfer.

Preferably, the draw-in rollers 81 and 82 should have a coefficient of roller skin friction smaller than that of the register roller 21. For instance, there may be a combination of draw-in rollers 81 and 82 having roller skins made of a POM (polyoxymethylene), and a register roller 21 having roller skins made of an NBR (acrylonitrile-butadiene rubber).

The draw-in rollers 81 and 82 may thus have a smaller coefficient of friction than the register roller 21, permitting the register roller 21 to exert greater nip pressures. As a result, there may be suppressed troubles in transfer of print sheet from the draw-in rollers 81 and 82 to the register 21.

Although illustrative embodiments of the present invention have been described, the invention is not limited to the embodiments described. The scope of the invention should be construed in accordance with appended claims in consideration of their equivalent scopes. The embodiments may be modified in part, as will be described below.

The embodiments described may have their constituent members modified in shape, arrangement, number, material, or the like, as necessary.

For instance, guide plates may be modified in shape, arrangement, or number, as necessary. In each embodiment described, although the guide plate 72 is configured as a single member doubled in use, the guide plate 72 may be configured as a combination of double members. Further, the guide plate 73 and the guide plate 74 may be integrated as a single member.

The drying duct has a measure for heating an inside thereof, which measure is not limited to the heating blower or fan, and may be implemented in any form capable of heating a print sheet. For instance, the drying duct may have a simple heating heater or heaters disposed in a transfer space therein.

Rollers may be replaced by other measures for transfer. For instance, the register roller as well as each draw-in roller may be may be substituted by a belt transfer measure disposed in a corresponding position.

What is claimed is:

1. A sheet transfer system comprising:
a register configured for a one-side printed print sheet and a non-printed print sheet in travel to be placed in a position;
a first guide portion configured with a first opening to guide the one-side printed print sheet to the register; and
a second guide portion configured with a second opening to guide the non-printed print sheet to the register,
the first opening having an opening angle greater than an opening angle of the second opening.

2. The sheet transfer system according to claim 1, wherein the first guide portion comprises a drawer adapted to draw in the one-side printed print sheet to the register.

3. The sheet transfer system according to claim 2, wherein the drawer is disposed on a side of the first guide portion to face a non-printed side of the one-side printed print sheet.

4. The sheet transfer system according to claim 2, further comprising a controller configured to control a drive force of the drawer, the controller being adapted for control to make faster a speed of the one-side printed print sheet being drawn in by the drawer, than a speed of the one-side printed print sheet being carried in to the first guide portion.

5. The sheet transfer system according to claim 1, wherein the first guide portion comprises a first pair of guide plates arranged to face both sides of the one-side printed print sheet, and the second guide portion comprises a second pair of guide plates arranged to face both sides of the non-printed print sheet, the first pair of guide plates and the second pair of guide plates being both tapered toward the register.

6. The sheet transfer system according to claim 5, wherein the opening angle of the first opening is defined as a crossing angle between tangential lines at sheet carry-in ends of the first pair of guide plates, and the opening angle of the second opening is defined as a crossing angle between tangential lines at sheet carry-in ends of the second pair of guide plates.

7. The sheet transfer system according to claim 5, wherein one guide plate of the first pair of guide plates is shared as one guide plate of the second pair of guide plates.

8. The sheet transfer system according to claim 2, wherein the register comprises a pair of rollers, and the drawer comprises a single roller.

9. A duplex printer comprising a sheet transfer system according to claim 1.
